(19) United States
(12) Patent Application Publication
(10) Pub. No.: US 2012/0107682 A1
(43) Pub. Date: May 3, 2012

(54) NONAQUEOUS ELECTROLYTE SECONDARY BATTERY AND METHOD FOR MANUFACTURING THE SAME

(75) Inventors: Naoki Imachi, Kobe-city (JP); Takanobu Chiga, Kobe-city (JP); Nobuhiro Sakitani, Itano-gun (JP)

(73) Assignee: SANYO ELECTRIC CO., LTD., Osaka (JP)

(21) Appl. No.: 13/247,385

(22) Filed: Sep. 28, 2011

(30) Foreign Application Priority Data
Oct. 27, 2010 (JP) 2010-240980

(51) Int. Cl. H01M 4/00; B05D 5/00; H01M 10/00

(52) U.S. Cl. 429/209; 427/77

(57) ABSTRACT

The present invention relates a nonaqueous electrolyte secondary battery with a porous layer containing inorganic particles formed on a surface of a positive electrode and provides a nonaqueous electrolyte secondary battery capable of reducing the incipient failure and having an excellent shelf life characteristic. The nonaqueous electrolyte secondary battery includes: a positive electrode containing a positive-electrode active material; a negative electrode containing a negative-electrode active material; a nonaqueous electrolyte; and a porous layer provided on a surface of the positive electrode, wherein the porous layer contains silica particles and an aqueous binder.

### BACKGROUND OF THE INVENTION

1. Field of the Invention

This invention relates to nonaqueous electrolyte secondary batteries and methods for manufacturing the same.

2. Description of Related Arts

In recent years, size and weight reduction of mobile information terminals, such as cellular phones, notebook computers, and PDAs, has rapidly progressed. Batteries for use as their driving power sources are being required to achieve a higher capacity. Furthermore, these mobile information terminals have enhanced their features, such as a video playback feature and a gaming feature, and have thereby tended to further increase the power consumption. Therefore, lithium ion secondary batteries as their driving power sources are being strongly required to achieve a still higher capacity and higher performance, such as a longer playback time or an improved power output.

WO2007/108425 describes that a porous layer made of inorganic particles (titanium oxide) is formed on a surface of a positive electrode, whereby the battery performance can be improved under high voltage and high temperature conditions.

WO2005/029614 describes that a porous layer is formed on a negative electrode using a solvent-based slurry made of inorganic particles, whereby the insulation property is increased and the battery stability is improved. This patent literature also describes that the inorganic particles are preferably made of inorganic oxides, particularly preferably made of alumina or titania but silica is not preferred as an inorganic oxide because it may be eroded by electrolyte.

JP-A-2009-302009 and JP-A-2010-192127 describe that a porous layer is formed on a positive electrode using an aqueous slurry made of inorganic particles (such as alumina, titania, zirconia or magnesia), whereby the high-temperature characteristic can be improved. These literatures also describe that the dispersibility problematic for aqueous slurries can be improved by addition of a polyacrylate or a glycol-based material.

### SUMMARY OF THE INVENTION

The inventors have found that, however, when a porous layer is formed on a positive electrode using an aqueous slurry containing inorganic particles, such as alumina particles or titania particles, as described in JPA-2009-302009 and JP-A-2010-192127, there arises a problem in that the incipient failure during manufacturing of nonaqueous electrolyte secondary batteries becomes high.

A nonaqueous electrolyte secondary battery according to the present invention is a nonaqueous electrolyte secondary battery including: a positive electrode containing a positive-electrode active material; a negative electrode containing a negative-electrode active material; a nonaqueous electrolyte; and a porous layer provided on a surface of the positive electrode, wherein the porous layer contains silica particles and an aqueous binder.

A manufacturing method according to the present invention is a method capable of manufacturing the above nonaqueous electrolyte secondary battery according to the present invention and the method includes the steps of: producing the positive electrode; forming the porous layer on a surface of the positive electrode by applying on the surface of the positive electrode an aqueous slurry containing the silica particles and the aqueous binder; and producing a nonaqueous electrolyte secondary battery using the positive electrode with the porous layer formed thereon, the negative electrode, and the nonaqueous electrolyte.

In the present invention, since the porous layer provided on a surface of the positive electrode is formed of a layer containing silica particles and an aqueous binder, the incipient failure of nonaqueous electrolyte secondary batteries can be reduced and the resultant nonaqueous electrolyte secondary batteries can have excellent shelf life characteristic.

### DETAILED DESCRIPTION

Next, the present invention will be described in more detail.

<Porous Layer>

A porous layer formed on a surface of a positive-electrode active material layer, even if transition metals, such as Co and Mn, are eluted from the positive-electrode active material, can inhibit deposition of these transition metals on a surface of a negative electrode and therefore can reduce degradation in shelf life characteristic at high temperatures.

A positive-electrode active material layer is generally formed from an organic solvent-based slurry containing an organic solvent, such as N-methyl-2-pyrrolidone (NMP), and a binder, such as poly(vinylidene fluoride) (PVDF). If in this case a porous layer is formed using PVDF or the like as a binder and NMP or the like as a solvent by applying such an organic solvent-based slurry for forming the porous layer on the positive-electrode active material layer, the solvent and the binder will be highly likely to diffuse into the active material layer to cause the binder in the active material layer to swell. To avoid this, in the present invention, a porous layer is formed from an aqueous slurry in which an aqueous binder is used as a binder for the porous layer. By using an aqueous binder as a binder for the porous layer, the porous layer can be formed on a surface of the positive-electrode active material layer without damage to the active material layer.

The inventors have found that if alumina particles or titania particles are used as inorganic particles contained in a porous layer and the porous layer is formed from an aqueous slurry containing an aqueous binder, a problem arises in that the incipient failure will be high. They have conducted intensive studies on the cause of the above problem and consequently have found that when such kinds of inorganic particles are dispersed into the aqueous slurry in a disperser, the disperser may wear to produce impurities, such as a SUS (stainless steel, JIS) component, and the impurities may be mixed into the slurry, resulting in a high incipient failure. If a resultant battery is charged and discharged, a potential of approximately 4.0 V will be applied to these impurities in the vicinity of the positive electrode and therefore Fe ions or like component will be dissolved. The dissolved component will be reduced on the negative electrode to precipitate thereon as a metal component, whereby a short circuit will be likely to occur between the positive and negative electrodes and thus an initial defect will be likely to occur.

Use of silica particles as inorganic particles contained in a porous layer can solve the above problem that would occur with the use of alumina or titania particles. More specifically, when a porous layer is formed of a layer containing silica particles and an aqueous binder in accordance with the present invention, the incipient failure can be reduced.

In the present invention, the thickness of the porous layer is preferably 4 μm or less, more preferably within the range of 0.5 to 4 μm, and particularly preferably within the range of 0.5 to 2 μm. If the thickness of the porous layer is too small, the effects obtained by forming the porous layer may be insufficient. On the other hand, if the thickness of the porous layer is too large, this may result in degraded load characteristic or reduced energy density of the resultant battery.

The content ratio of the aqueous binder to the silica particles in the porous layer is preferably 30 parts by mass or less of the aqueous binder per 100 parts by mass of the silica particles, more preferably 10 parts by mass or less of the aqueous binder, and still more preferably 5 parts by mass or less of the aqueous binder. If the content of the aqueous binder is too large, voids in the porous layer will be filled in, whereby the lithium ion permeability through the intervention of the electrolyte solution will be reduced and thus the charge-discharge performance will be degraded. The lower limit of the content ratio of the aqueous binder to the silica particles is generally 0.1 parts by mass or more.

Next, a description is given of the silica particles and the aqueous binder for use in the porous layer.

(Silica Particles)

The average particle size of silica particles for use in the present invention is preferably 1 μm or less and more preferably within the range of 0.01 to 0.6 μm. When the average particle size of silica particles is within the above range, the incipient failure can be further reduced.

The surfaces of silica particles in the present invention are preferably hydrophilic. Surface-hydrophilic silica particles have many siloxane groups or silanol groups on their surfaces and these groups provide a lubrication effect during dispersion process. Thus, the wear load of a disperser can be further reduced. Therefore, mixture of impurities due to wear of the disperser can be more effectively prevented.

In the present invention, since silica particles are used as inorganic particles contained in the porous layer, the dispersibility in a slurry is more excellent than when alumina or titania particles are used as inorganic particles. Therefore, the amount of water-soluble dispersant, such as carboxymethyl cellulose Na salt (CMC), can be reduced and a slurry having a good dispersed state can be prepared without the use of water-soluble dispersant. The reduction in the amount of water-soluble dispersant further enhances the shelf life characteristic. Examples of the water-soluble dispersant include CMC, polyvinyl pyrrolidone (PVP), and polyvinyl alcohol (PVA).

The purity of silica particles for use in the present invention is preferably 99% by mass or more. By using silica particles having a purity of 99% by mass or more, the incipient failure can be further reduced.

Silica particles for use in the present invention are preferably fumed silica. Preferred for use among various kinds of fumed silica is silica produced by a dry ultrafine-particle pyrogenic process. If silica particles are attempted to be produced by dry grinding, there will arise a problem of mixture of impurities and silica particles of small average particle size will be difficult to obtain at low cost. Although silica particles produced by wet process can also be used, they have large numbers of pores and thereby have excessively large surface area. Therefore, if an aqueous slurry is prepared using such silica particles, good handling ability may not be achieved. Examples of available silica produced by the dry ultrafine-particle pyrogenic process are silicas manufactured by Evonik Degussa.

(Aqueous Binder)

Although no particular limitation is placed on the aqueous binder for use in the porous layer in the present invention, it preferably should satisfy all the following properties: (1) reliable dispersibility of inorganic particles (prevention of reaggregation), (2) reliable adhesion that can withstand the battery production process, (3) filling of spaces between inorganic particles through swelling after the absorption of the nonaqueous electrolyte and (4) less elution of the nonaqueous electrolyte. Examples of such an aqueous binder include styrene-butadiene rubber (SBR), polytetrafluoroethylene (PTFE), polyacrylonitrile (PAN), their modified products and derivatives, copolymers containing acrylonitrile units, and polyacrylic acid derivatives. The aqueous binder is preferably used in the form of emulsion resin or water-soluble resin.

<Slurry for Forming Porous Layer>

A slurry for forming the porous layer can be prepared using the above-described silica particles and aqueous binder. The solvent mainly used for the slurry is water. If an organic solvent, such as NMP, is used as a solvent in a slurry for forming the porous layer, the dispersion stability of the slurry will be good but a problem will arise in that the solvent and binder in the slurry may diffuse into the active material layer to cause swelling of the binder in the active material layer, resulting in reduced energy density. The use of water as the solvent in the slurry can solve this problem and is preferred from an environmental standpoint.

However, in order to further improve the wear resistance of the above disperser, a small amount of organic solvent may be added as a lubricant to the slurry. For example, an organic solvent is preferably added up to 35% by mass with respect to aqueous solvent. The reason for this limit is that if the proportion of the organic solvent is too high, the dispersion stability of inorganic particles will be impaired. Examples of the organic solvent that can be used include N-methylpyrrolidinone and acetone.

The respective concentrations of silica particles and aqueous binder in the slurry can be appropriately controlled in consideration of the porosity of the slurry or other factors. The preferred methods for dispersing silica particles into the slurry are wet dispersion methods using “FILMIX” manufactured by PRIMIX Corporation or a bead mill. Particularly, since it is preferred that the filler for use in the present invention have a small average particle size, it is preferred that the filler should be subjected to a mechanical dispersion process. Therefore, for example, a dispersion method for use in dispersing paint is preferably used.

Examples of a method for applying the slurry on a surface of the positive electrode include die coating, gravure coating, dip coating, curtain coating, and spray coating. Among them, gravure coating or die coating is preferably used. Considering reduction in adhesive strength due to diffusion of the solvent and binder into the inside of the electrode, a method capable of coating the slurry at high speed and providing a short drying time is preferred. Although the solid content concentration in the slurry varies depending on the coating method, the solid content concentration in spray coating, dip coating or curtain coating, which have difficulty mechanically controlling the thickness, is preferably low, for example, preferably within the range of 3% to 30% by mass. On the other hand, in using die coating or gravure coating, the slurry may have a high solid content concentration. The solid content concentration in these methods is preferably about 5% to about 70% by mass.

<Positive-Electrode Active Material>

Examples of the positive-electrode active material for use in the present invention are materials having a layered structure. The particularly preferred material for use is a lithium-containing transition metal oxide having a layered structure. Examples of such a lithium-containing transition metal oxide are lithium composite oxides, including lithium cobaltate, Co—Ni—Mn-containing lithium composite oxide, Al—Ni—Mn-containing lithium composite oxide, and Al—Ni—Co-containing lithium composite oxide. Particularly preferred for use is a positive-electrode active material whose capacity can be increased when the end-of-charge potential of the positive electrode is 4.30 V (vs. Li/Li⁺) or more. The above various kinds of positive-electrode active materials may be used alone or in a mixture of two or more.

<Negative-Electrode Active Material>

No particular limitation is placed on the negative-electrode active material for use in the present invention so long as it can be used as a negative-electrode active material for a nonaqueous electrolyte secondary battery. Examples of the negative-electrode active material include carbon materials, such as graphite and coke; metal oxides, such as tin oxide; metals that can form an alloy with lithium to store lithium, such as silicon and tin; and metal lithium.

<Nonaqueous Electrolyte>

The solvent for a nonaqueous electrolyte that can be used in the present invention is any solvent conventionally used as a solvent for an electrolyte in a nonaqueous electrolyte secondary battery. Particularly preferred solvents for use are mixture solvents of a cyclic carbonate and a chain carbonate. Specifically, it is preferred that the mixture ratio between the cyclic carbonate and the chain carbonate (cyclic carbonate to chain carbonate) be within the range of 1:9 to 5:5. Examples of the cyclic carbonate include ethylene carbonate, propylene carbonate, butylene carbonate, and vinylene carbonate. Examples of the chain carbonate include dimethyl carbonate, methyl ethyl carbonate, and diethyl carbonate.

Examples of the solute for a nonaqueous electrolyte that can be used in the present invention include LiPF₆, LiBF₄, LiCF₃SO₃, LiN(CF₃SO₂)₂, LiN(C₂F₅SO₂)₂, LiC(CF₃SO₂)₃, LiC(C₂F₅SO₂)₃, and mixtures thereof.

Examples of the electrolyte that may be used include gel polymer electrolytes in which a polymer electrolyte, such as polyethylene oxide or polyacrylonitrile, is impregnated with an electrolyte solution, and inorganic solid electrolytes, such as LiI and Li₃N.

No particular limitation is placed on the electrolyte usable for a nonaqueous electrolyte secondary battery according to the present invention, so long as the lithium compound as a solute for developing ion conductivity and the solvent for dissolving and retaining the lithium compound therein are not decomposed by application of voltage during battery charge and discharge or battery storage.

<Nonaqueous Electrolyte Secondary Battery>

A nonaqueous electrolyte secondary battery according to the present invention can be produced using the positive electrode with the porous layer produced in the above manner on a surface thereof, the negative electrode, and the nonaqueous electrolyte.

The nonaqueous electrolyte secondary battery according to the present invention is preferably charged so that the end-of-charge potential of the positive electrode reaches 4.30 V (vs. Li/Li⁺) or more. When in this manner the battery is charged so that the end-of-charge potential of the positive electrode is higher than in conventional cases, the charge/discharge capacity can be increased. On the other hand, when the end-of-charge potential of the positive electrode is increased, a transition metal, such as Co or Mn, may be likely to be eluted from the positive-electrode active material. However, the present invention can reduce degradation in high-temperature shelf life characteristic resulting from deposition of the eluted Co or Mn on the negative electrode surface.

Furthermore, the nonaqueous electrolyte secondary battery according to the present invention has an excellent shelf life characteristic at high temperatures. Therefore, when the nonaqueous electrolyte secondary battery according to the present invention is used in an operating environment at 50° C. or higher, the effect can be significantly performed.

In the present invention, the nonaqueous electrolyte secondary battery is more preferably charged so that the end-of-charge potential of the positive electrode reaches 4.35 V (vs. Li/Li⁺) or more, still more preferably 4.40 V (vs. Li/Li⁺) or more. Thus, the charge/discharge capacity of the nonaqueous electrolyte secondary battery can be further increased. If a carbon material is used as a negative-electrode active material, the end-of-charge potential of the negative electrode will be approximately 0.1 V (vs. Li/Li⁺). When in this case the end-of-charge potential of the positive electrode is 4.30 V (vs. Li/Li⁺), the resultant end-of-charge voltage will be 4.20 V. When the end-of-charge potential of the positive electrode is 4.40 V (vs. Li/Li⁺), the resultant end-of-charge voltage will be 4.30 V.

It is known that, generally, when the end-of-charge potential of a positive electrode is 4.35 V (vs. Li/Li⁺) or more, the retention capacity rate of a battery in a storage test at 60° C. drastically decreases. The reason for this can be explained as follows. When the end-of-charge potential of the positive electrode increases, the elution of Co or the like from the positive-electrode active material and the decomposition reaction of the electrolyte solution will frequently occur. Therefore, the retention capacity rate decreases with increasing end-of-charge potential of the positive electrode.

In the present invention, the ratio of the charge capacity of the negative electrode to the charge capacity of the positive electrode (negative electrode charge capacity to positive electrode charge capacity) is preferably within the range of 1.0 to 1.1. By setting the positive electrode to negative electrode charge capacity ratio at 1.0 or more, it can be prevented that metal lithium precipitate on the surface of the negative electrode. Therefore, the cycle life characteristic and safety of the battery can be improved. On the other hand, if the positive electrode to negative electrode charge capacity ratio exceeds 1.1, the energy density per volume may decrease, which is unfavorable. The above positive electrode to negative electrode charge capacity ratio is set depending on the end-of-charge voltage of the battery.

### EXAMPLES

Hereinafter, the present invention will be described in more detail with reference to specific examples; however, the present invention is not limited at all by the following examples and can be embodied in various other forms appropriately modified without changing the spirit of the invention.

### Example 1

### Formation of Positive-Electrode Active Material Layer

Lithium cobaltate, acetylene black serving as a conductive carbon material, and poly(vinylidene fluoride) (PVDF) were mixed in a mass ratio of 95:2.5:2.5 into NMP serving as a solvent with a kneader to prepare a slurry for a positive electrode mixture.

The prepared slurry was applied on both surfaces of a piece of aluminum foil serving as a positive-electrode current collector, then dried and rolled to form positive-electrode active material layers on the positive-electrode current collector. The packing density in the positive-electrode active material layer was 3.60 g/cm³.

[Formation of Porous Layer]

Silica particles (SiO₂, hydrophilic fumed silica with an average particle size of 40 nm and a surface area of 50 m²/g, manufactured by Nippon Aerosil Co., Ltd. under the trade name “AEROSIL 50”) were used as inorganic particles to be contained in a porous layer. The purity of silica particles used was 99% by mass or more. Silica particles for use in all of the following examples also have a purity of 99% by mass or more.

SBR emulsion was used as an aqueous binder and carboxymethyl cellulose Na salt (CMC) was used as a dispersant. An aqueous slurry was prepared using the above silica particles, the aqueous binder, and the dispersant. The solid content concentration of the silica particles in the slurry was 20% by mass. The aqueous binder was used to give a concentration of 3 parts by mass per 100 parts by mass of the silica particles. The dispersant, or CMC, was mixed with the above materials to give a concentration of 0.2 parts by mass per 100 parts by mass of the silica particles. The mixed slurry was subjected to a dispersion process with a disperser “FILMIX” (with a container made of SUS stainless steel) manufactured by PRIMIX Corporation to prepare an aqueous slurry t1.

The aqueous slurry was coated by gravure coating on the surfaces of the positive-electrode active material layers and water as the solvent was dried and removed, whereby porous layers were formed on the respective positive-electrode active material layers lying on both surfaces of the positive electrode. The thickness of the porous layer on each side was 2 μm and the total thickness of the porous layers on both sides was 4 μm.

[Production of Negative Electrode]

A carbon material (graphite) was used as a negative-electrode active material and CMC and SBR were also used. The negative-electrode active material, CMC, and SBR were mixed together to give a mass ratio of 98:1:1, thereby preparing a slurry for forming a negative-electrode mixture layer. The slurry for forming a negative electrode mixture layer was applied on both surfaces of a piece of copper foil, then dried and rolled to produce a negative electrode. The packing density of the negative-electrode active material was 1.60 g/cm³.

[Preparation of Nonaqueous Electrolyte Solution]

Ethylene carbonate (EC) and diethyl carbonate (DEC) were mixed to give a volume ratio of 3:7. Added to the resultant mixture solvent was LiPF₆ to reach a concentration of 1 mol/L, thereby preparing a nonaqueous electrolyte solution.

[Assembly of Battery]

Lead terminals were attached to the above positive and negative electrodes, a separator was interposed between the electrodes, and these components were helically wound up together and pressed down in a flattened form to produce an electrode assembly. The electrode assembly was inserted into an aluminum laminate serving as a battery outer package, the above nonaqueous electrolyte solution was then poured into the aluminum laminate, and the aluminum laminate was then sealed to produce a test battery. The design capacity of the battery was 750 mAh. The battery was designed to have an end-of-charge voltage of 4.4 V and designed so that the capacity ratio between positive and negative electrodes (first charge capacity of negative electrode to first charge capacity of positive electrode) at 4.4 V was 1.05. The separator used was a macroporous polyethylene membrane having an average pore diameter of 0.1 μm, a thickness of 16 μm, and a porosity rate of 47%.

The lithium secondary battery produced in the above manner is hereinafter referred to as a battery T1.

### Example 2

An aqueous slurry t2 and a battery T2 were produced in the same manner as in Example 1 except for the use of silica particles (SiO₂, hydrophilic fumed silica with an average particle size of 20 nm and a surface area of 90 m²/g, manufactured by Nippon Aerosil Co., Ltd. under the trade name “AEROSIL 90”) as inorganic particles.

### Example 3

An aqueous slurry t3 and a battery T3 were produced in the same manner as in Example 1 except for the use of silica particles (SiO₂, hydrophilic fumed silica with an average particle size of 16 nm and a surface area of 130 m²/g, manufactured by Nippon Aerosil Co., Ltd. under the trade name “AEROSIL 130”) as inorganic particles.

### Example 4

An aqueous slurry t4 and a battery T4 were produced in the same manner as in Example 1 except for the use of silica particles (SiO₂, hydrophobic fumed silica with an average particle size of 16 nm and a surface area of 110 m²/g, manufactured by Nippon Aerosil Co., Ltd. under the trade name “AEROSIL 972”) as inorganic particles.

### Example 5

An aqueous slurry t5 and a battery T5 were produced in the same manner as in Example 1 except that no CMC was added as a constituent of the aqueous slurry.

### Comparative Example

A battery was produced in the same manner as in Example 1 except that no porous layer was formed on the surfaces of the positive electrode. This battery is hereinafter referred to as a comparative battery R1.

### Comparative Example 2

An aqueous slurry r2 and a battery R2 were produced in the same manner as in Example 1 except for the use of alumina particles (Al₂O₃, high-purity alumina with an average particle size of 500 nm and a surface area of 4.6 m²/g, manufactured by Sumitomo Chemical Co., Ltd. under the trade name “AKP 3000”) as inorganic particles.

### Comparative Example 3

An aqueous slurry r3 and a battery R3 were produced in the same manner as in Example 1 except for the use of titania particles (TiO₂, high-purity rutile titania with an average particle size of 250 nm and a surface area of 6.8 m²/g, manufactured by Ishihara Sangyo Kaisha, Ltd. under the trade name “CR-EL”) as inorganic particles.

[Measurement of Impurities in Aqueous Slurry]

The aqueous slurries for forming porous layers prepared in the above Examples and Comparative Examples were evaluated for the amount of impurities mixed thereinto during dispersion process. Specifically, 500 g of each aqueous slurry after the dispersion process and a magnet for impurity recovery were put into a polyethylene container with a cover and the container was covered and shaken for an hour. Thereafter, the magnet was recovered and rinsed with water and impurities attracted to the magnet were evaluated for size and composition using scanning electron microscopy (SEM) and energy dispersive X-ray analysis (EDX). More specifically, whether impurity particles with a diameter greater than 50 μm were present or not was evaluated by SEM. The evaluation results are shown in TABLE 1. As for the aqueous slurries before the dispersion process, no impurity particles with a diameter greater than 50 μm were collected because of the use of high-purity inorganic particles.

TABLE 1

| | | Impurities | Dispersion |
|---|---|---|---|
| Aqueous | CMC | Collected | Stability |
| Slurry | Addition | by Magnet | of Slurry |
| t1 | Yes | None | Good |
| t2 | Yes | None | Good |
| t3 | Yes | None | Good |
| t4 | Yes | None | Good |
| t5 | No | None | Good |
| r2 | Yes | Present | Good |
| r3 | Yes | Present | Good |

As shown in TABLE 1, impurity particles with a diameter greater than 50 μm were observed in the positive electrode slurries r2 and r3 in which alumina particles or titania particles were used as inorganic particles. When the composition of these impurity particles was evaluated by EDX, it was found that the impurities were those containing Fe (Fe alone or SUS stainless steel).

Since no impurities were observed in each aqueous slurry before the dispersion process, it can be considered that the above impurities were mixed in the slurries during the dispersion process. Furthermore, since the impurities are those containing Fe, it is highly possible that the disperser container (made of SUS) was worn by the aqueous slurries. Particularly, when water is used as a solvent, the lubrication effect is smaller than an organic solvent, so that the disperser will be likely to be damaged during dispersion of inorganic particles. In addition, when as for titanium and alumina an electrochemically more stable, higher-purity material is selected as inorganic particles, the hardness of the particles tend to increase, which will make the disperser very likely to wear. It can be considered that for these reasons the aqueous slurries r2 and r3 contained an increased amount of impurities with a diameter greater than 50 μm.

On the other hand, no impurity particles were observed in the examples in which silica was used as inorganic particles. This can be attributed to the fact that not only the hardness of the particles was low but also siloxane groups or silanol groups on the surfaces of the particles had an effect like a lubricant to reduce, even with the use of SUS as the disperser container, wear of the container due to the aqueous slurry.

Furthermore, in the cases of use of hydrophilic silica, the resultant slurries exhibited good dispersion stability even when no CMC was added thereto as in the aqueous slurry t5. This is advantageous in that the need for extra additive, such as CMC serving as a dispersant, is eliminated and the effects of additives on the battery performance can be reduced. Moreover, it can be assumed that hydrophilic silica particles have large numbers of silanol groups or siloxane groups on their surfaces, whereby not only the dispersion performance but also the buffering effect can be strongly exhibited to effectively reduce impurities (wear of the disperser).

[Evaluation of Shelf Life Characteristic]

The batteries of the above Examples and Comparative Examples were evaluated for shelf life characteristic in the following manner.

Each battery was subjected to a single charge-discharge cycle test under the following conditions and then continuously charged again at 60° C. for 3 days without being cut off at a lower current limit. Thereafter, the battery was cooled down to room temperature and discharged at a rate of 1 It. Then, the retention capacity rate was calculated from the following equation.

Retention capacity rate (%)={(discharge capacity after continuous charging storage test)/(discharge capacity before storage test)}×100

Charge Conditions:

Each battery was charged to 4.4 V at a constant current of 1 It (750 mA) and then charged to a current of 1/20 It (37 mA) at a constant voltage.

Discharge Conditions:

Each battery was discharged to 2.75 V at a constant current of 1 It (750 mA).

Pause:

A 10-minute pause was introduced between the above charging and discharging.

The shelf life characteristics (retention capacity rates) of the batteries at 60° C. are shown in TABLE 2. The TABLE 2 also shows incipient failures evaluated based on the following criterion.

[Incipient Failure]

Thirty samples for each battery were produced and the incipient failure of the thirty samples was evaluated based on the following criterion relating to the initial charge/discharge efficiency.

Battery percent defective (%)={(the number of battery samples having an initial charge/discharge efficiency of 85% or less)/(the number of evaluated battery samples (i.e., 30))}×100

TABLE 2

| | Porous Layer | | | Shelf Life |
|---|---|---|---|---|
| | on Positive | Impurities | | Characteristic |
| | Electrode | (Collected | Incipient | Retention |
| Battery | Surface | by Magnet) | Failure | Capacity Rate |
| T1 | Present | None | 0/30 0% | 82% |
| T2 | Present | None | 0/30 0% | 81% |
| T3 | Present | None | 0/30 0% | 81% |
| T4 | Present | None | 1/30 3% | 80% |
| T5 | Present | None | 0/30 0% | 84% |
| R1 | Absent | — | 0/30 0% | 76% |
| R2 | Present | Present | 14/30 47% | 81% |
| R3 | Present | Present | 10/30 33% | 82% |

First, comparison of T1 to T5 with R1 shows that the provision of a porous layer significantly improved the shelf life characteristic at high temperatures.

Furthermore, as clearly seen from the results shown in TABLE 2, the batteries T1 to T5 exhibited significantly lower incipient failures than the batteries R2 and R3. In addition, there was no substantial difference in shelf life characteristic at high temperatures between the set of batteries T1 to T5 and the set of batteries R2 and R3. Therefore, the use of SiO₂ as inorganic particles can provide a battery significantly improved in incipient failure while exhibiting an excellent shelf life characteristic at high temperatures.

The battery T4, in which hydrophobic silica was used, exhibited only a little higher incipient failure than the batteries of the other inventive Examples. The reason for this may be that with the use of hydrophilic silica its lubrication effect makes impurities less likely to be mixed into the slurry, while with the use of hydrophobic silica mixture of impurities occurs in a level unobservable by SEM. Therefore, it can be seen that the use of hydrophilic silica particles is more preferred.

However, even with the use of hydrophobic silica, a sufficient quality to allow mass production can be ensured such as by introducing a screening process using a magnet. The battery T5 with no CMC added thereto improved its shelf life characteristic than the battery T1 with CMC added thereto. It can be seen from this that the shelf life characteristic can be further improved by using no water-soluble dispersant, such as CMC. Moreover, it can also be seen that in the present invention, even without using a water-soluble dispersant, such as CMC, silica particles can be well dispersed in the slurry and a nonaqueous electrolyte secondary battery with excellent shelf life characteristic can be provided.

TABLE 2 shows that the incipient failure of R1 was 0%, while the incipient failures of R2 and R3 were over 30%. These results show that initial defects can be due to the formation of a porous layer. It can be considered that for this reason the incipient failure of R1 with no porous layer formed thereon was 0%. It can also be considered that the incipient failure of T4 reached 3% for the same reason, i.e., because of the formation of a porous layer. However, it can be said that considering the incipient failure of T4 and the shelf life characteristics of T4 and R1 at high temperatures, the effects of formation of a porous layer using hydrophobic silica are significant.

As can be seen from the above, in the present invention, in the process of preparing an aqueous slurry for forming a porous layer to be provided on the surfaces of the positive electrode, mixture of impurities due to wear of the disperser can be significantly reduced. This prevents the occurrence of defects due to small short-circuit between the positive and negative electrodes inside the battery. In addition, the effect of improving the shelf life characteristic at high temperatures owing to the formation of a porous layer can be maintained, which is effective in increasing the battery performance.

What is claimed is:

1. A nonaqueous electrolyte secondary battery comprising: a positive electrode containing a positive-electrode active material; a negative electrode containing a negative-electrode active material; a nonaqueous electrolyte; and a porous layer provided on a surface of the positive electrode,
wherein the porous layer contains silica particles and an aqueous binder.

2. The nonaqueous electrolyte secondary battery according to claim 1, wherein the average particle size of the silica particles is 1 μm or less.

3. The nonaqueous electrolyte secondary battery according to claim 1, wherein the surfaces of the silica particles are hydrophilic.

4. The nonaqueous electrolyte secondary battery according to claim 1, wherein the silica particles are fumed silica.

5. The nonaqueous electrolyte secondary battery according to claim 3, wherein the silica particles have siloxane groups and/or silanol groups on the surfaces thereof.

6. A method for manufacturing the nonaqueous electrolyte secondary battery according to claim 1, the method comprising the steps of:
producing the positive electrode;
forming the porous layer on a surface of the positive electrode by applying on the surface of the positive electrode an aqueous slurry containing the silica particles and the aqueous binder; and
producing a nonaqueous electrolyte secondary battery using the positive electrode with the porous layer formed thereon, the negative electrode, and the nonaqueous electrolyte.
